(19) United States
(12) Patent Application Publication
(10) Pub. No.: US 2008/0310312 A1
(43) Pub. Date: Dec. 18, 2008

(54) Method for Monitoring SIP Call-Flows by Tracking Message Transformation

(75) Inventors: Arup Acharya, Nanuet, NY (US); Nilanjan Banerjee, Kolkata (IN); Bikram Sengupta, New Delhi (IN)

Correspondence Address: GEORGE A. WILLINGHAN, III;AUGUST LAW GROUP, LLC, P.O. BOX 19080, BALTIMORE, MD, 21284-9080, US

(73) Assignee: INTERNATIONAL BUSINESS MACHINES CORPORATION, Armonk, NY (US)

(21) Appl. No.: 11/764,011

(22) Filed: Jun. 15, 2007

(51) Int. Cl. G06F 11/00

(52) U.S. Cl. 370/241

(57) ABSTRACT

Systems and methods are provided for monitoring session initiation communications without modifying the operational code of the session initiation protocol proxy servers through which the messages that constitute a given communication are routed. The inbound and outbound versions of session initiation protocol messages are identified at a plurality of proxy servers. The inbound and outbound message versions are correlated at each proxy server using user-defined correlation rules that test conditions of the message headers. The correlated inbound and outbound message versions are then examined for transformations, and these transformations are used to determine the actions taken by the appropriate proxy server on that message. These actions are used to check the proper operation of both the proxy server and the session initiation protocol communication.

### FIELD OF THE INVENTION

The present invention relates to session initiation protocol communications.

### BACKGROUND OF THE INVENTION

Session Initiation Protocol (SIP) is the key technology behind Voice-over-Internet Protocol (VoIP), Instant Messaging (IM) and Presence, and is the basis for IMS (IP Multimedia Subsystems). SIP is a hop-by-hop control protocol that connects one or more clients together within the context of a given communication session, for example voice and video communication sessions and conferencing sessions. This control protocol operates over multiple intermediate servers, called SIP proxies or SIP proxy servers that among other functions, route the SIP messages that are part of a given SIP communication session. As part of this routing action, new headers are added to a given SIP header and existing headers (and values) are deleted or changed in the SIP message. In addition, the SIP proxy server may undergo a state change due to the routing action.

A given system or network contains numerous distributed SIP proxy servers that handle numerous simultaneous SIP messages associated with a multitude of SIP communication sessions. Both the sequence of SIP messages and the SIP proxy servers need to be monitored for proper operation. However, monitoring a distributed system of SIP servers in real-time without invasively instrumenting the SIP proxy software is difficult. SIP-based network infrastructure forms the foundation of delivering a variety of communication services, the highest availability and superior scalability needs to be maintained to match the voice service expectations and demands. Such quality of service (QoS) guarantees can be provided by deploying management technologies that can measure service quality and identify the problems that are affecting the user experiences. Current approaches typically include off-line inspection of a log by logging all messages flowing through a server. However, log entries do not contain adequate information or require additional significant effort to recreate the message transformation.

Let us first motivate the challenges through a common problem. When a phone call fails to go through, especially in early stages of a deployment, users contact a help desk system (through the phone itself if it is reachable, through alternate communication such as IM/email etc.). In such situations, it may not always be possible to retrace the user's original call context, by retrieving the logs from all possible servers and trying to retrace the path of the call and detect the root cause by inspecting logs. For one, every server may not maintain a call log (SIP systems, unlike phone systems, contain a distributed set of servers and a service is obtained by routing a call between a subset of these servers, which may vary between call to call); it is usually only a few key servers that maintain call-detail records, e.g., outbound SIP proxy that forwards calls outside the domain. In such a situation, it is often useful if the help desk can retry the call and retrace the path of a call within the network in real-time. Besides, real-time monitoring of calls is useful for mining online information about individual ongoing calls as well as aggregate network information and may be used for efficient network management operations.

### SUMMARY OF THE INVENTION

The present invention is direct to systems and methods for monitoring SIP communication sessions without modifying the operating code of SIP proxy servers. A SIP communication session is conducted by exchanging a plurality of SIP messages between clients through a plurality of SIP proxy servers. The SIP messages include text-based headers and their corresponding values. The action a given server takes on an SIP message passing through that server is deduced from the transformation that was performed on that message by the SIP proxy server. For example, if the destination uniform resource identifier (URI) on an INVITE message was modified from the inbound version of an SIP message to the outbound message of the SIP message, it is deduced that the SIP server performed an SIP redirection action. Monitoring the actions taken by the SIP proxy servers through the monitoring of message transformations can be done in real-time and does not require instrumenting the SIP proxy software or off-line analysis of a log.

In addition to identifying the changes or transformations between inbound and outbound SIP messages, the inbound SIP messages need to be correlated to the outbound SIP messages at a given SIP proxy server, e.g. correlating an incoming call transfer request (REFER) with an outgoing setup call (INVITE) to referred party. Correlation between inbound and outbound messages and identification of the transformation between the correlated inbound and outbound messages are used for verifying that the necessary message transformations are happening as expected, for a given SIP communication session, i.e., correlation is used to diagnose problems in and to debug the SIP communication session. In addition, transformations between correlated inbound and outbound messages are used to verify that a given SIP server is behaving as expected, e.g. by correlating the Join headers of an INVITE to earlier INVITEs acting as conference setup messages, any changes from a normal operating mode of a conference server can be detected. Finally, correlation may be used to identify messages pertaining to a single dialog/session and help generate footprints that aid in real-time monitoring of SIP dialogs/sessions.

In order to correlate inbound messages with outbound messages, a set of correlation rules for SIP are created to match an inbound SIP message with an outbound message that is a transformed version of the former. These correlations rules can be defined for specific contexts. For a point-to-point call, the Call-ID header field remains an invariant across hops. When a call forks, the tag field in the To header can be used to correlate across the different forking paths. For a conference call, ongoing conference calls can be identified by the Dialog identifier that can be used to correlate new callers joining an existing conference, with a matching Join header in the INVITE. When a call in transferred to a third party by using a REFER message, the REFER contains a header Refer-to (and a sub-header/option Replaces) that can be used to correlate with the existing call that is being transferred. In case of presence, a PUBLISH message that updates state at a presence server may give rise to a number of NOTIFY messages. A PUBLISH and the corresponding NOTIFY's can be correlated through the event-package that is being used.

Having created the correlation rules, the inbound and outbound messages at a given SIP proxy server are correlated using these rules. The correlated messages and the associated transformations are used to diagnose a call-flow. A given end-to-end call can be broken into a series of expected transformations, and the correlation mechanism is used to install rules on each hop of the expected path to verify whether the expected transformations are indeed taking place and to identify points of divergence between expected and observed behavior.

In one embodiment, to track the flow and transformation of SIP messages, a software engine called SIP message classification engine or classifier is incorporated within the operating system (OS) of a server machine. The actual SIP software, e.g., SIP proxy, runs as an application on this server, for example, routing SIP messages. Placing the classification engine within the OS is desirable for reasons of efficiency as well as architecturally, depending on the specific scenario. The classifier is programmable, and, therefore, the same software can be used for various application scenarios, by using an appropriate set of rules. An efficient algorithm is created that takes as input a set of user-defined rules and morphs these rules into suitable data structures that enable fast matching of rules against the input message stream. The rules specify both how to identify specific subsets of messages based on a combination of message header values including complex functions such as set membership as well as operations on the state amassed at the classifier from previous messages, and the actions to be executed on the matching packets. These actions include parsing the inbound and outbound message streams from the server and generating footprints. The footprints contain selected message meta-data including distinguishing headers-value pairs and their transformations and are forwarded by the classifier to a central monitoring engine. The central monitoring engine collates this information from different servers or classifiers across the network to infer the state of a SIP session on individual servers on the call path as well as aggregated call-state.

The present invention is directed to methods for monitoring session initiation protocol communications by identifying a plurality of transformations in a plurality of session initiation protocol messages produced by a session initiation protocol proxy server and using the identified transformations to verify proper operation of at least one of session initiation protocol communication sessions containing the identified messages and the session initiation protocol proxy server. In one embodiment of the method for monitoring session initiation protocol communications, at least one transformation is identified in a session initiation protocol message produce by a session initiation proxy server through which the session initiation protocol message is routed. This identified transformation is used to deduce an action performed on the session initiation protocol message by the session initiation protocol proxy server, and this deduced action is used to verify proper operation of at least one of a session initiation protocol communication session containing the identified message and the session initiation protocol proxy server.

In one embodiment, an inbound version of the session initiation protocol message at the session initiation protocol proxy server is identified, and an outbound version of the session initiation protocol message at the session initiation protocol proxy server is also identified. Differences between the incoming version and the outgoing version of the session initiation protocol message can then be determined. In one embodiment, a state model, e.g., a finite state machine, for each one of a plurality of session initiation protocol communications is identified. Therefore, using the deduced action further can include using the deduced action in combination with the state model for the session initiation protocol communication session containing the identified message to infer a global state for at least one of the session initiation protocol communication session containing the identified message and the session initiation protocol proxy server.

In one embodiment, the method for monitoring session initiation protocol communication includes identifying a plurality of transformations in a plurality of session initiation protocol messages produced by a session initiation protocol proxy server. All of these identified transformations are used to deduce actions performed on each one of the session initiation protocol messages by the session initiation protocol proxy server, and the deduced actions are used to verify proper operation of at least one of session initiation protocol communication sessions containing the identified messages and the session initiation protocol proxy server. In one embodiment, inbound versions and outbound version of the session initiation protocol messages are identified at the session initiation protocol proxy server. Differences between the inbound versions and the outbound versions of the session initiation protocol messages are identified. In one embodiment, the inbound versions with outbound versions are correlated.

In one embodiment, correlation of the inbound and outbound version of the messages includes defining one or more correlation rule sets. Each rule set includes a plurality of correlation rules. At least one of the correlation rule sets is used to match each inbound session initiation protocol message with one of the outbound session initiation protocol messages. The correlation rules can be modified based upon type of session initiation protocol message or type of session initiation protocol communication session. In one embodiment, each correlation rule contains a conjunction of conditions to be used in assessing inbound and outbound versions of the messages and actions to be taken in accordance with the assessment of the inbound and outbound versions of the messages. These conditions operate on session initiation protocol headers associated with the inbound and outbound versions of the messages. In one embodiment, the session initiation protocol headers include pre-defined session initiation protocol headers, user defined pseudo-headers, derived headers comprising components of other headers and combinations thereof.

The present invention is also directed to a method for monitoring session initiation protocol communications by identifying inbound versions and outbound versions of a plurality of session initiation protocol messages at a session initiation protocol proxy server. The inbound versions and outbound version are correlated, and differences between correlated inbound versions and the outbound versions of the session initiation protocol messages are identified. The identified differences are used to deduce actions performed on each one of the session initiation protocol messages by the session initiation protocol proxy server. The deduced actions are used to verify proper operation of at least one of session initiation protocol communication sessions containing the identified messages and the session initiation protocol proxy server.

In one embodiment, correlation of the inbound and outbound version of the messages includes defining one or more correlation rule sets. Each rule set includes a plurality of correlation rules. In one embodiment, at least one of the correlation rule sets is used to match each inbound session initiation protocol message with one of the outbound session initiation protocol messages. The correlation rules can be modified based upon type of session initiation protocol message or type of session initiation protocol communication session. In one embodiment, each correlation rule contains a conjunction of conditions to be used in assessing inbound and outbound versions of the messages and actions to be taken in accordance with the assessment of the inbound and outbound versions of the messages. These conditions operate on session initiation protocol headers associated with the inbound and outbound versions of the session initiation protocol messages.

### BRIEF DESCRIPTION OF THE DRAWINGS

FIG. 1 is a schematic representation of an embodiment of a session initiation protocol architecture for use in accordance with the present invention;

FIG. 2 is a schematic representation of an embodiment of a session initiation protocol setup and media path;

FIG. 3 is a schematic representation of an embodiment of a call on hold;

FIG. 4 is a schematic representation of an embodiment of a footprint pattern and state model for call hold;

FIG. 5 is a schematic representation of an embodiment of a monitoring architecture for use in accordance with the present invention; and

FIG. 6 is a schematic representation of an embodiment of monitoring a session initial protocol message by a session initial protocol server in accordance with the present invention.

### DETAILED DESCRIPTION

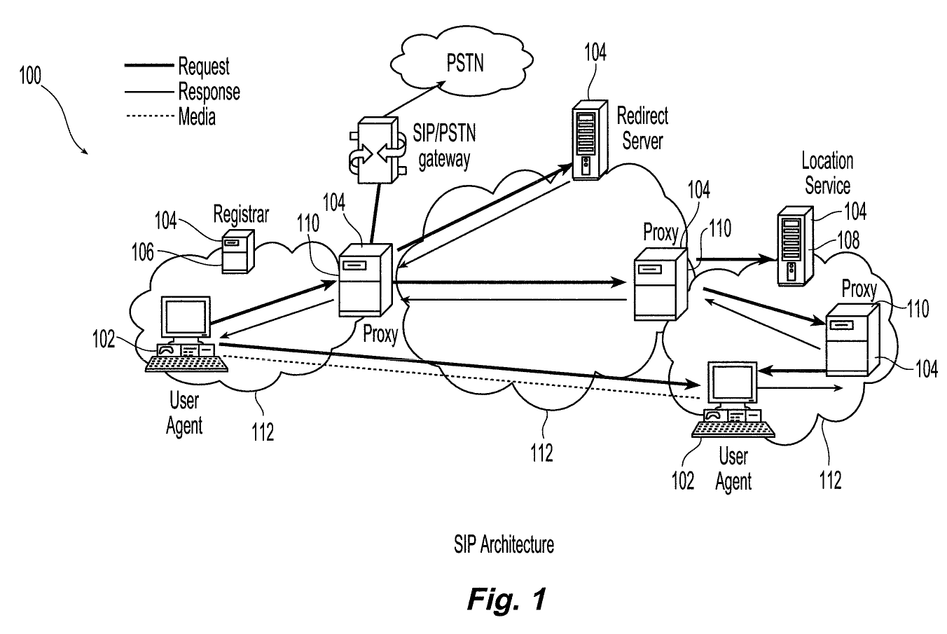

Referring initially to FIG. 1, an exemplary embodiment of a SIP infrastructure 100 for use in the monitoring systems and methods of the present invention is illustrated. The SIP infrastructure contains a plurality of user agents (UAs) 102 and a plurality of SIP servers 104. The SIP servers include registration servers 106, location servers 108 and SIP proxy servers 110 deployed across one or more networks 112. Each UA represents a SIP endpoint that controls session setup and media transfer. The SIP protocol is described in detail in J. Rosenberg et al., SIP: Session Initiation Protocol, RFC 3261, IETF, June 2002.

SIP messages are requests or responses. For example, INVITE is a request while “180 Ringing” or “200 OK” are responses. Each SIP message contains a set of headers and values, which are specified as strings, with a syntax similar to hypertext transfer protocol (HTTP) but much richer in variety, usage and semantics. For example, a given header can occur multiple times, have list of strings as its value and a number of sub-headers, called parameters, each with an associated value. The following example illustrates an invitation from Alice to Bob to begin a dialog:
INVITE sip:bob biloxi.com SIP/2.0
Via: SIP/2.0/UDP pc33.atlanta.com;branch=z9h
Max-Forwards: 70
To: Bob <sip:bob biloxi.com>
From: Alice <sip:alice@atlanta.com>;tag=192
Call-ID: a84b4c76e66710@pc33.atlanta.com
CSeq: 314159 INVITE
Contact: <sip:alice@pc33.atlanta.com>
Content-Type: application/sdp
Content-Length: 142
(Alice's Session Description not shown)

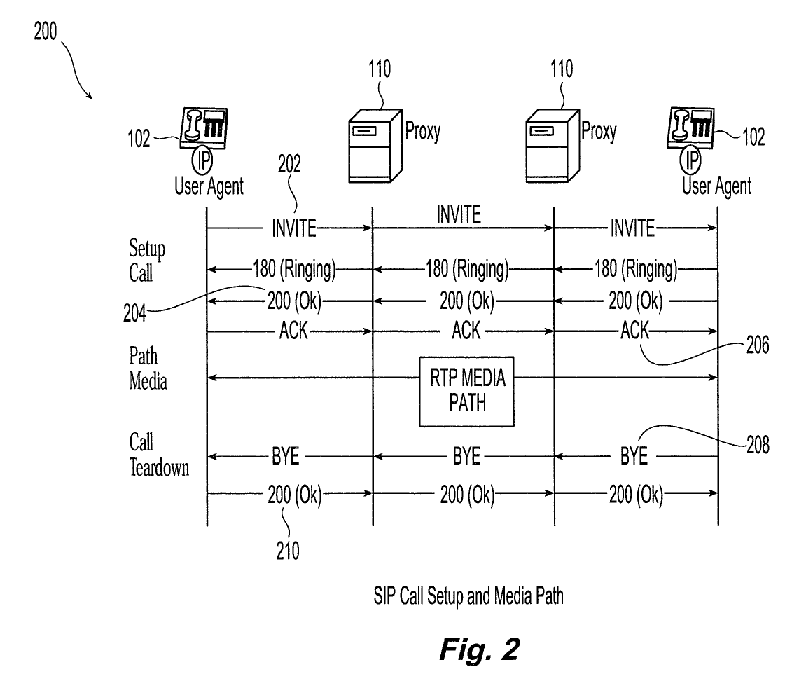

SIP messages are routed through SIP proxies to setup sessions between UAs. All requests, e.g., INVITE, are routed by the proxy to the appropriate destination UA based on the destination SIP URI included in the message. Referring to FIG. 2, an exemplary embodiment of a call set up followed by media exchange using rich text format (RTF) 200 is illustrated. A session is commonly set up between two user agents 102 through an INVITE request 202, an OK response 204 and an ACK to the response 206. The SIP communications session is torn down through an exchange of BYE 208 and OK 210 messages.

Numerous variations to the signaling sequence illustrated in FIG. 2 are possible, for example multiple INVITE/OK/ACK exchanges during a call-lifetime, modifying a SIP communication session, e.g., call handoff in cellular environments or the addition of a video session, forking of the INVITE message to multiple targets, looping back on the request path or redirection. In addition, conference calls are common, where multiple endpoints signal to common control server, i.e., conference server.

There are three different types of associations that happen between the UAs in a SIP network. The first type of association is a SIP transaction. A SIP transaction occurs between a client and a server and contains all messages from the first request sent from the client to the server up to a final (non-1xx) response sent from the server to the client. The second type is a multimedia session, which is a set of multimedia senders and receivers and the data streams flowing from senders to receivers. A multimedia conference is an example of a multimedia session. The third type is a dialog, which is a peer-to-peer SIP relationship between two UAs that persists for some time. A dialog is established by SIP messages, for example 2xx responses to an INVITE request. A dialog is identified by a call identifier, local tag and a remote tag. A dialog is also referred to as a call leg.

Methods in accordance with the present invention identify message transformations that occur at each one of the SIP proxy servers to determine the actions taken by the SIP proxy servers for purposes of monitoring the operation of SIP communication sessions and the SIP proxy servers. A given server receives a plurality of SIP messages. Therefore, each SIP proxy server can have a plurality of concurrent inbound versions and outbound version of the SIP messages. In order to determine the SIP message transformations, the inbound versions of the messages need to be correlated to the outbound versions of the messages.

In one embodiment, a plurality of user-defined correlation rules are identified, for example from a repository or database, or inputted by one or more users. These correlation rules are used to correlate or to match inbound versions of SIP messages with outbound versions of SIP messages at each SIP proxy server. Each user-defined correlation rule can be expressed as a conjunction of conditions followed by an action. The conditions operate on headers associated with the SIP messages. These headers include predefined SIP headers, pseudo-headers, which we define for convenience, e.g., message_type, and derived headers, which are composed from other headers. In one embodiment, the header From.tag represents the “tag” parameter within the From header and is derived from the From header. The Dialog-ID derived header includes Call-Id, a SIP header, From.tag, derived from From SIP header and representing the tag field of From, and To.tag. Methods in accordance with the present invention support user-defined data types, i.e., scalars, pointers and associative arrays, that include basic data types, e.g., String or Integer, or other user-defined data types. A user-specified state is maintained that can be updated as part of rule actions. For example, in Struct Session={Dialog Dialog1, String State}, the element “State” stores the state of a dialog, which could be “established”, “setup” or “shutdown”. Condition evaluations can have side-effects. For example, if the Dialog-id of the current SIP message is an element in a list of active sessions, the following condition evaluation results in storing a pointer to the matching element, which, for example, could then be used to modify any associated data structures as part of a rule action.

*CurrentSession=(Dialog-ID belongs-to % ActiveSessions)

Each one of the plurality of identified correlation rules includes a conjunction of conditions and an associated list of actions. These actions can further change variable values.

In one embodiment, the classification algorithm includes a static component and a runtime component. The static component includes rule parsing and creating several tables and bitmaps that allow the runtime portion to operate efficiently. The key to generating these efficient structures is that most redundancy is eliminated from the rule set, so that the runtime phase does not need to repetitively extract headers or evaluate conditions. The runtime component includes parsing individual SIP messages, comparing these parsed messages to the correlation rules and performing a set of actions when a SIP message matches a rule.

Since SIP transactions are typically very short-lived, SIP transactions are not suitable for real-time operational monitoring. But, the functional validation of a SIP network with the monitoring system can be done using SIP transaction model and a synthetic SIP transaction. SIP dialogs and sessions, on the other hand, are quite enduring. Therefore, functional monitoring and real-time operational monitoring of dialogs and sessions for online mining of individual dialog and session information as well as the aggregate information, are quite feasible.

Exemplary embodiments of systems and methods in accordance with the present invention utilize a “model” of the SIP dialog or SIP communication session. This model captures the various possible states for the SIP dialog along with the footprint patterns expected at each state. States correspond to the progress of the SIP dialog, starting from an invitation being sent out, intermediate routing through different proxies, forking of messages if needed, and arrival at the destinations. SIP based calls may also be put on hold, forwarded or transferred. These SIP dialogs can be represented by corresponding state-machine models, e.g., finite state machines. State transitions in these models are triggered by the sending and receiving of SIP messages, which can be simplified into footprint records. A footprint record is obtained by extracting relevant portions of a SIP message using a classifier attached to a SIP proxy. For example, if Call-Id is invariant for a particular SIP dialogue, a footprint record may only contain the message type, e.g., Invite, the Call-Id and the proxy address of the SIP server where the message is being sent from or received. Since the classifier operates at the OS layer, real-time generation of footprint records is enabled. The footprint records are matched against the footprint patterns associated with the different states of the dialog model. A footprint pattern may be considered as an abstract representation of a footprint record, containing placeholders for concrete header values, which are instantiated during matching. For example, a footprint pattern “INVITE<Proxy><Call-id>” corresponding to a state where an invitation is in transit, may match with a footprint record “INVITE 9.123.44.78 ac34h56p33.atlanta.com”, with Call-id bound to ac34h56@p33.atlanta.com and Proxy-address set to 9.123.44.78. As a SIP invitation proceeds through the system, the Call-id will remain the same, but the Proxy-address will change, and these bindings will allow us to trace the call through the network.

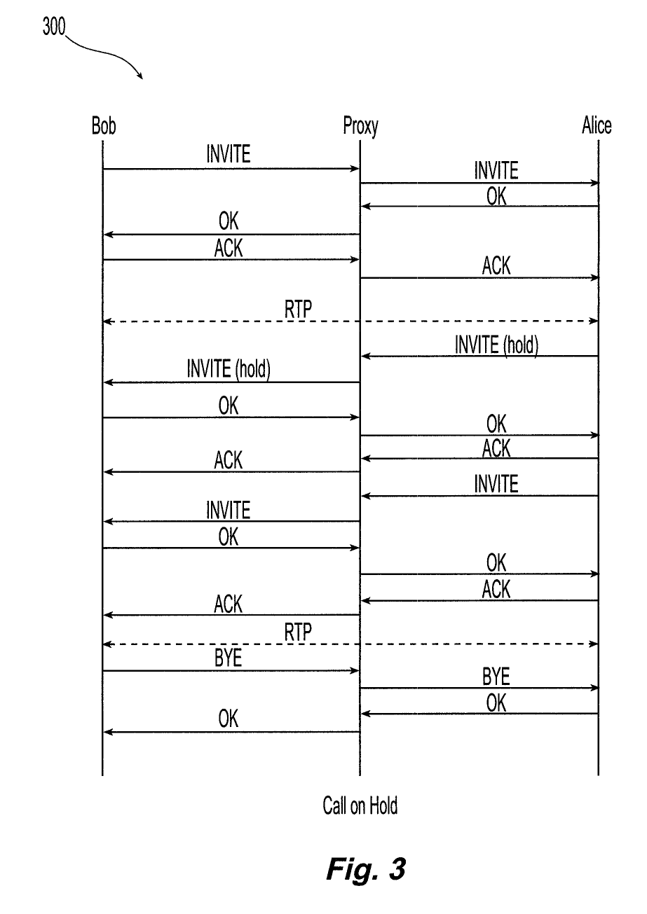

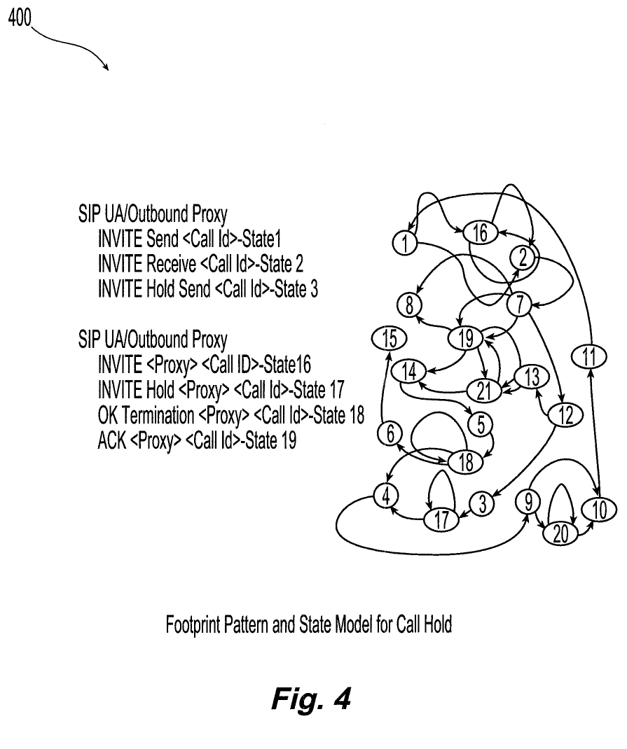

Referring to FIG. 3, an exemplary embodiment of a message diagram for a call on hold 300 SIP service. The state model representing the service 400 with the corresponding footprint (shown partially) generated by the classifier from the SIP messages in the different SIP entities is illustrated in FIG. 4. This model can be used by the SIP monitoring engine (SME) to track in real-time the SIP dialogs that are put on hold. Although the message diagram shows only one intermediate proxy, there can be a finite number of such proxies in general. This does not indicate an explosion in states as number of SIP proxies increase, since the states and footprint patterns are abstract and are not bound to one particular proxy. Rather, the states and footprint patterns are dynamically bound to different proxies as the dialog progresses. Similarly, state machines can be created for other SIP services, and these state machines can be composed hierarchically to encode different possibilities in a SIP dialog.

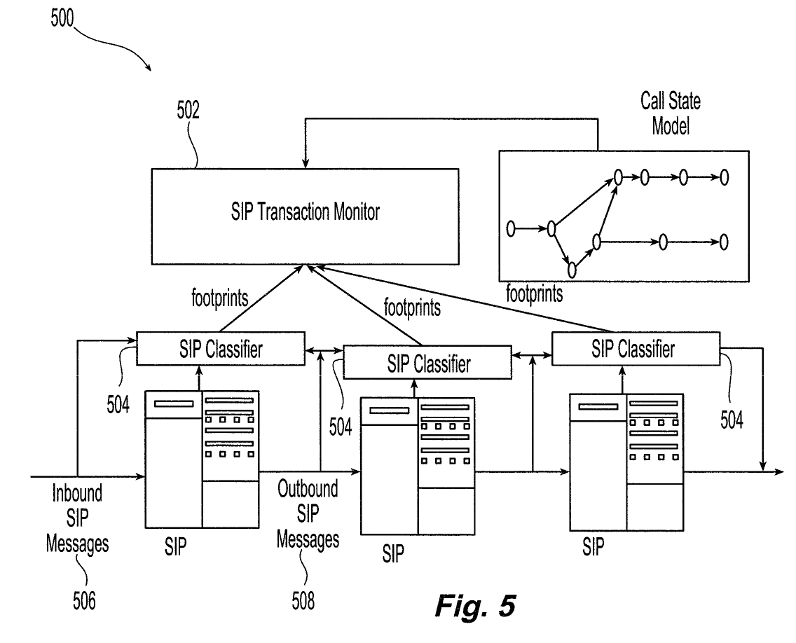

Referring to FIG. 5, an exemplary embodiment of the architecture 500 of the SIP monitoring system of the present invention is illustrated. The architecture includes a SME 502 and one or more SIP classifiers 504. Each SIP classifier can be logically thought of as monitoring both inbound versions of SIP messages 506 and outbound versions of SIP messages 508, with different sets of rules on each side. One way to identify how a given SIP message is transformed while traversing a SIP proxy is to place a pair of rules, one on the inbound side message stream and the other on the outgoing side message stream of the SIP proxy. By correlating matching messages, the specific transformation of each message by the SIP proxy can be identified, e.g., the destination URI was re-written for a message that had a matching Call-ID on the outbound version. In another example, the identification of a new participant joining an ongoing two-party call to converting the call to a 3-party conference call is made. The classifier can be programmed to look for the Join header on an INVITE message from the new party whose value matches any of the in-progress Dialog-IDs.

The SME receives as inputs footprint records of ongoing SIP dialogs and sessions, generated by the classifiers and a model of SIP dialogs or sessions, in terms of the states, and the corresponding expected footprint patterns. Given these inputs, for each ongoing dialog or session instance, SME employs a model matching algorithm to determine in real-time the state the instance may be in. In addition, aggregate-level information, e.g., number of instances at any given state of the model, may also be determined in real-time. Such statistics are helpful in efficient management of networks. The monitoring algorithm in SME requires identifying the footprint records corresponding to a particular dialog or session for monitoring individual dialogs or sessions.

For many of the services, messages corresponding to a single dialog or session can be identified using the Call-ID in the message header. But, message headers and header values often get changed as a SIP message is routed through a network. A common use for destination URI re-writing is to instantiate a URI such as sip:bob@biloxi.com to sip:bob@bobs-host.biloxi.com, i.e., resolve a user within a domain to a specific host in the domain. The ability to correlate the incoming INVITE (with destination sip:bob@biloxi.com) with the outgoing INVITE (to bob@bobs-host.biloxi.com) is useful for diagnostic purposes. Another instance of redirection is where an INVITE for sip:bob@biloxi.com from user (UA1) is responded with a 302 MOVED response by a redirect server1 (PI), with a Contact: sip:bob@blues.com. This 302 message on the return path may trigger a new INVITE using sip:bob@blues.com at a proxy (P2) which is eventually routed to Bob's client (UA2). Thus, being able to correlate the INVITE with the corresponding 302 would allow a real-time monitoring system to infer that the call originating from UA1 traversed through PI and P2 with aforementioned modifications to the message, before reaching UA2, i.e. the call was forwarded to a new destination and the identity of the forwarding entity.

In the above two examples, an invariant is the Call-ID header value. For a non-forking call, the combination of Call-ID, and the tag (sub-header) values in the From and To headers values remains unchanged. When a call forks or the call gets redirected, each forked/redirected leg of the call has a different tag value in the To header. The Call-ID header value of the incoming INVITE can be correlated with the outgoing Call-ID field. However, there are many other instances where even the Call-ID field is not sufficient to correlate messages. For example, in services such as call transfer or joining a conference call, a different subset of headers and their values needs to be used to correlate the messages. For example, when a call is transferred to a third party by using a REFER message, the REFER contains a header Refer-to and a sub-header/option Replaces, which can be used to correlate with the existing call that is being transferred. This is where the programmability of the classifier comes into play. The classifier can be programmed to look for different subsets of headers depending on the function of a server, e.g., a Redirect server.

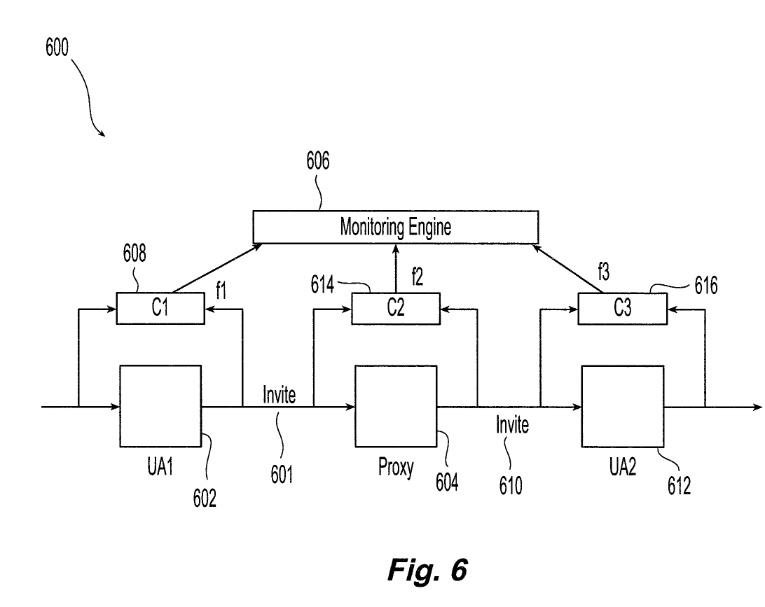

Referring to FIG. 6, an exemplary embodiment of SIP message monitoring by a SIP proxy server 600 in accordance with the present invention is illustration. A first user agent 602 sends in Invite message 601, <Call-id=1><Req-URI=bob@us>, that is routed through a SIP proxy server 604. This is the inbound version of the message at the proxy server. A first SIP classifier 608 monitors this message and communicates it to the SME 606. The SIP proxy 604 receives the inbound version of the SIP and generates an outbound version 610 of the Invite message that is forwarded to a second user agent 612. The outbound version has the format Invite <Proxy-addr=9.23.123.34><Call-id=1><Req-URI=bob@9.2.10>. A second SIP classifier 614 receives and correlates the incoming and outgoing versions of the SIP messages using Call-id and infers that destination URI is being re-written. The second SIP classifier generates a footprint where the Call-id is the same, but the destination URI is different, and also includes the proxy address. The outbound version of the invite 610 is received at the second user agent 612, <Call-id=1>Req-URI=bob@9.2.10, and this received SIP messages is monitored by a third SIP classifier 616. When the invite is sent, the monitoring engine 606 starts a new call instance with token values Call-id=1 and Req-URI=bob@us. When the SME receives a communication from the second SIP classifier regarding the correlated inbound and outbound versions of the SIP message, the SME correlates this communication with the Invite received from the first SIP classifier 608 and updates Req-URI. In addition, the SME creates a new token for proxy-address. If there are more proxies, the SME may store newer proxy addresses as a list so that the entire path may be traced.

In one embodiment, the session initiation protocol message monitoring system of the present invention is deployed in the context of a help desk agent. The help desk agent sketches the expected call flow in the network and subsequently derives a call state model for a sample service scenario. The SIP classifiers are configured at the SIP proxy servers in the call path with appropriate rules to monitor a call in real-time and to confirm if the expected changes are taking place, i.e., retrace the path of the call in real-time. If an anomaly is detected, additional rules can be instantiated to dig deeper. The operator can create a stimulus and the monitoring system can be used to detect the stimulus and its response at different parts of the system. Besides such functional testing of a network, the monitoring system yields aggregate information, e.g., number of dialogs in a particular state or average dialog termination time among others, as well as individual information, e.g., which state is a dialog in at a particular instant of time, on the call paths of the ongoing SIP dialogs and sessions. This information is useful in the deployment of effective network management tools such as load balancing.

Methods and systems in accordance with exemplary embodiments of the present invention can take the form of an entirely hardware embodiment, an entirely software embodiment or an embodiment containing both hardware and software elements. In a preferred embodiment, the invention is implemented in software, which includes but is not limited to firmware, resident software and microcode. In addition, exemplary methods and systems can take the form of a computer program product accessible from a computer-usable or computer-readable medium providing program code for use by or in connection with a computer, logical processing unit or any instruction execution system. For the purposes of this description, a computer-usable or computer-readable medium can be any apparatus that can contain, store, communicate, propagate, or transport the program for use by or in connection with the instruction execution system, apparatus, or device. Suitable computer-usable or computer readable mediums include, but are not limited to, electronic, magnetic, optical, electromagnetic, infrared, or semiconductor systems (or apparatuses or devices) or propagation mediums. Examples of a computer-readable medium include a semiconductor or solid state memory, magnetic tape, a removable computer diskette, a random access memory (RAM), a read-only memory (ROM), a rigid magnetic disk and an optical disk. Current examples of optical disks include compact disk-read only memory (CD-ROM), compact disk-read/write (CD-R/W) and DVD.

Suitable data processing systems for storing and/or executing program code include, but are not limited to, at least one processor coupled directly or indirectly to memory elements through a system bus. The memory elements include local memory employed during actual execution of the program code, bulk storage, and cache memories, which provide temporary storage of at least some program code in order to reduce the number of times code must be retrieved from bulk storage during execution. Input/output or I/O devices, including but not limited to keyboards, displays and pointing devices, can be coupled to the system either directly or through intervening I/O controllers. Exemplary embodiments of the methods and systems in accordance with the present invention also include network adapters coupled to the system to enable the data processing system to become coupled to other data processing systems or remote printers or storage devices through intervening private or public networks. Suitable currently available types of network adapters include, but are not limited to, modems, cable modems, DSL modems, Ethernet cards and combinations thereof.

In one embodiment, the present invention is directed to a machine-readable or computer-readable medium containing a machine-executable or computer-executable code that when read by a machine or computer causes the machine or computer to perform a method for monitoring session initiation protocol communication flows in accordance with exemplary embodiments of the present invention and to the computer-executable code itself The machine-readable or computer-readable code can be any type of code or language capable of being read and executed by the machine or computer and can be expressed in any suitable language or syntax known and available in the art including machine languages, assembler languages, higher level languages, object oriented languages and scripting languages. The computer-executable code can be stored on any suitable storage medium or database, including databases disposed within, in communication with and accessible by computer networks utilized by systems in accordance with the present invention and can be executed on any suitable hardware platform as are known and available in the art including the control systems used to control the presentations of the present invention.

While it is apparent that the illustrative embodiments of the invention disclosed herein fulfill the objectives of the present invention, it is appreciated that numerous modifications and other embodiments may be devised by those skilled in the art. Additionally, feature(s) and/or element(s) from any embodiment may be used singly or in combination with other embodiment(s) and steps or elements from methods in accordance with the present invention can be executed or performed in any suitable order. Therefore, it will be understood that the appended claims are intended to cover all such modifications and embodiments, which would come within the spirit and scope of the present invention.

What is claimed is:

1. A method for monitoring session initiation protocol communications, the method comprising:
identifying a transformation in a session initiation protocol message produce by a session initiation proxy server through which the session initiation protocol message is routed;
using the identified transformation to deduce an action performed on the session initiation protocol message by the session initiation protocol proxy server; and
using the deduced action to verify proper operation of at least one of a session initiation protocol communication session containing the identified message and the session initiation protocol proxy server.

2. The method of claim 1, wherein the step of identifying the transformation further comprises:
identifying an inbound version of the session initiation protocol message at the session initiation protocol proxy server;
identifying an outbound version of the session initiation protocol message at the session initiation protocol proxy server; and
identifying differences between the incoming version and the outgoing version of the session initiation protocol message.

3. The method of claim 1, wherein:
the method further comprises identifying a state model for each one of a plurality of session initiation protocol communications; and
the step of using the deduced action further comprises using the deduced action in combination with the state model for the session initiation protocol communication session containing the identified message to infer a global state for at least one of the session initiation protocol communication session containing the identified message and the session initiation protocol proxy server.

4. A method for monitoring session initiation protocol communications, the method comprising:
identifying a plurality of transformations in a plurality of session initiation protocol messages produced by a session initiation protocol proxy server;
using the identified transformations to deduce actions performed on each one of the session initiation protocol messages by the session initiation protocol proxy server; and
using the deduced actions to verify proper operation of at least one of session initiation protocol communication sessions containing the identified messages and the session initiation protocol proxy server.

5. The method of claim 4, wherein the step of identifying the transformations further comprises:
identifying inbound versions of the session initiation protocol messages at the session initiation protocol proxy server;
identifying outbound versions of the session initiation protocol messages at the session initiation protocol proxy server; and
identifying differences between the inbound versions and the outbound versions of the session initiation protocol messages.

6. The method of claim 4, wherein the step of identifying the transformations further comprises:
identifying inbound versions of the session initiation protocol messages at the session initiation protocol proxy server;
identifying outbound versions of the session initiation protocol messages at the session initiation protocol proxy server; and.
correlating inbound versions with outbound versions.

7. The method of claim 6, wherein the step of correlating the inbound and outbound version of the messages further comprises defining one or more correlation rule sets, each rule set comprising a plurality of correlation rules.

8. The method of claim 7, further comprising using at least one of the correlation rule sets to match each inbound session initiation protocol message with one of the outbound session initiation protocol messages.

9. The method of claim 7, further comprising modifying the correlation rules based upon type of session initiation protocol message or type of session initiation protocol communication session.

10. The method of claim 7, wherein each correlation rule comprises a conjunction of conditions to be used in assessing inbound and outbound versions of the messages and actions to be taken in accordance with the assessment of the inbound and outbound versions of the messages.

11. The method of claim 10, wherein the conditions operate on session initiation protocol headers associated with the inbound and outbound versions of the messages.

12. The method of claim 11, wherein the session initiation protocol headers comprise pre-defined session initiation protocol headers, user defined pseudo-headers, derived headers comprising components of other headers or combinations thereof.

13. A method for monitoring session initiation protocol communications, the method comprising:
identifying inbound versions of a plurality of session initiation protocol messages at a session initiation protocol proxy server;
identifying outbound versions of the session initiation protocol messages at the session initiation protocol proxy server;
correlating inbound versions with outbound versions;
identifying differences between correlated inbound versions and the outbound versions of the session initiation protocol messages;
using the identified differences to deduce actions performed on each one of the session initiation protocol messages by the session initiation protocol proxy server; and
using the deduced actions to verify proper operation of at least one of session initiation protocol communication sessions containing the identified messages and the session initiation protocol proxy server.

14. The method of claim 13, wherein the step of correlating the inbound and outbound version of the messages further comprises defining one or more correlation rule sets, each rule set comprising a plurality of correlation rules.

15. The method of claim 14, further comprising using at least one of the correlation rule sets to match each inbound session initiation protocol message with one of the outbound session initiation protocol messages.

16. The method of claim 14, further comprising modifying the correlation rules based upon type of session initiation protocol message or type of session initiation protocol communication session.

17. The method of claim 14, wherein each correlation rule comprises a conjunction of conditions to be used in assessing inbound and outbound versions of the messages and actions to be taken in accordance with the assessment of the inbound and outbound versions of the messages.

18. The method of claim 17, wherein the conditions operate on session initiation protocol headers associated with the inbound and outbound versions of the session initiation protocol messages.

19. A method for monitoring session initiation protocol communications, the method comprising:
identifying a plurality of transformations in a plurality of session initiation protocol messages produced by a session initiation protocol proxy server; and
using the identified transformations to verify proper operation of at least one of session initiation protocol communication sessions containing the identified messages and the session initiation protocol proxy server.
